(19) United States
(12) Patent Application Publication
(10) Pub. No.: US 2026/0043937 A1
(43) Pub. Date: Feb. 12, 2026

(54) Automated system for rapid X-ray screening of hand luggage

(71) Applicant: LINEV Systems, Inc., Conroe, TX (US)

(72) Inventors: Vladimir N. Linev, Spring, TX (US); Dzmitryi Bairashewski, Minsk (BY)

(21) Appl. No.: 19/263,024

(22) Filed: Jul. 8, 2025

Related U.S. Application Data
(60) Provisional application No. 63/680,989, filed on Aug. 8, 2024.

(51) Int. Cl. G01V 5/22; G01N 23/04

(52) U.S. Cl. CPC G01V 5/228; G01N 23/04; G01N 2223/1016; G01N 2223/3307; G01N 2223/401; G01N 2223/408; G01N 2223/414; G01N 2223/639; G01N 2223/643

(57) ABSTRACT

Scanner, including housing; first conveyor that transports luggage into housing; first plurality of sensors detects presence of luggage on first conveyor; second conveyor transports luggage through housing; second plurality of sensors detects presence of luggage on the second conveyor; pickup table for luggage pieces that do not require manual inspection; third conveyor that transports luggage to pickup table; first conveyor does not move luggage into housing as long as previous luggage was not sent to pickup table or until luggage taken from first conveyor; first X-ray source with first beam direction; second X-ray source with second beam direction, wherein first and second beam directions are 50-60 degrees apart; wherein first X-ray source has 100-160 KVolt on its anode; wherein second X-ray source has 100-160 KVolt on its anode; first detector detects first X-ray beam after luggage passes through beam; second detector detects second beam after luggage passes through beam.

### FIELD OF THE INVENTION

The present invention relates to the design of an X-ray system for screening hand luggage that is faster than conventional luggage screening systems and does not require inspection or analysis of X-ray images themselves by security personnel. The design combines scanning of items by an X-ray beam in two perspectives at non-right angles, automatic threat detection by machine vision, and automatic feeding and release of items to be screened.

### BACKGROUND OF THE RELATED ART

Conventional X-ray systems for luggage screening that exist today are capable of screening 250-300 bags per hour, while certain events can have tens of thousands of attendees, making conventional systems inefficient because many such systems are required, and all must be adequately manned. Other institutions, such as schools, may not require processing tens of thousands of people, but have severe time constraints on how much time the screening should take. In addition, a large number of systems would require a lot of space, which can be in short supply. Therefore, it is problematic to inspect each and every bag at a mass event, thus compromising the overall security of the event or institutions.

Accordingly, there is a need in the art for a scanning system that addresses the above problems.

### SUMMARY OF THE INVENTION

Accordingly, in one aspect, there is provided a scanner, including a housing; a first conveyor that transports a luggage piece into the housing; a first plurality of sensors that detects a presence of the luggage piece on the first conveyor; a second conveyor that transports the luggage piece through the housing for scanning; a second plurality of sensors that detects a presence of the luggage piece on the second conveyor; pick up table for luggage pieces that do not require manual inspection; a third conveyor that transports a luggage piece to the pick up table; wherein the first conveyor does not move the luggage piece into the housing as long as a previous luggage piece was not sent to the pick up table or until the luggage piece is taken from the second conveyor for manual inspection; a first X-ray source with a first X-ray beam direction; a second X-ray source with a second X-ray beam direction, wherein the first and second X-ray beam directions are 50-60 degrees apart; wherein the first X-ray source has 100-160 KVolt on its anode; wherein the second X-ray source has 100-160 KVolt on its anode; a first detector that detects the first X-ray beam after the luggage piece passes through the beam; and a second detector that detects the second X-ray beam after the luggage piece passes through the beam.

Optionally, luggage is automatically fed onto a third conveyor, based on results of luggage analysis by the machine vision algorithm in case it does not show a suspicious object in the luggage piece. Optionally, the first and second X-ray sources are underneath the second conveyor. Optionally, the first and second detectors are above the second conveyor. Optionally, a machine vision algorithm is used to combine images from the first and second detectors, analyze images to identify threats. Optionally, a display monitor shows machine vision image analysis results and type of threat. Optionally, a workstation runs the machine vision algorithm that analyzes the X-ray images and makes a decision whether a threat is present in the luggage piece. Optionally, there is a display monitor where the luggage piece is further inspected if a threat is suspected.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 shows an automated system for rapid X-ray screening of hand luggage.

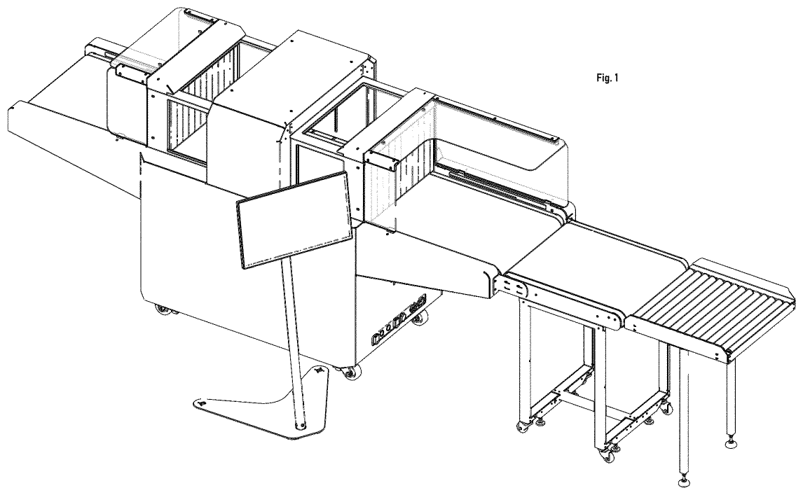

FIG. 2 shows the main components of the system.

FIG. 3 shows a geometry of X-ray beams at the 50-60 degree angles.

FIG. 4 shows a handgun at the 90-degree perspective.

FIG. 5 shows a handgun at the 50-degree perspective.

FIG. 6 shows a dense, bulky item in a bag.

FIG. 7 shows a plurality of positioning sensors, their components and location.

FIG. 8 shows simplified schematic format for threat visualization.

### DETAILED DESCRIPTION OF EMBODIMENTS OF THE INVENTION

Reference will now be made in detail to the preferred embodiments of the present invention, examples of which are illustrated in the accompanying drawings.

The present invention comprises a special X-ray scanner design and method that combines several conventional technologies, adapting them to increase the throughput of the X-ray scanner by a factor of more than 2x×. In addition, the proposed design, together with the technologies used, allows for a smaller size of the scanner, making it easier to use at mass events where space is limited.

The present disclosure generally describes the design of an X-ray scanner and methods of processing X-ray images to enable automatic screening of hand luggage two or more times faster than is normally possible.

One embodiment of the invention combines a number of technical solutions into a single system to significantly increase the speed of hand luggage inspection. As such, the following is possible:
1. The speed of the conveyor is 3-5 times faster;

The location of the luggage item in the scanner is controlled using a set of position sensors, which can definitively detect whether the luggage item is ready for scan, and whether the previously scanned item has been taken for inspection by a security guard if the luggage was identified as suspicious;
2. The hand luggage is initially located onto a first conveyor with a first set of positioning sensors, where it awaits inspection;
3. The hand luggage is automatically fed onto the second conveyor, based on the results of the previous screening;
4. The hand luggage is scanned from two perspectives by X-ray beams that are oriented at non-right angles to each other in order to reduce scanner footprint without prohibited items detection accuracy decrease when mathematical machine vision algorithms are used;
5. Mathematical machine vision algorithms are used that can detect prohibited items in hand luggage automatically and quickly;
6. If the luggage piece does not have suspicious objects, it is automatically transferred to the third conveyor, where the luggage piece is then moved to the pick up table, for the owner to retrieve it.
7. The luggage piece is automatically retained in the additional inspection zone at the end of the second conveyor before the third conveyor, if a suspicious object has been detected. The scanner can pause the scanning while this occurs.
8. The automatic inspection continues as soon as security personnel take the suspicious luggage off the conveyor, and the second set of positioning sensors of the second conveyor is cleared;

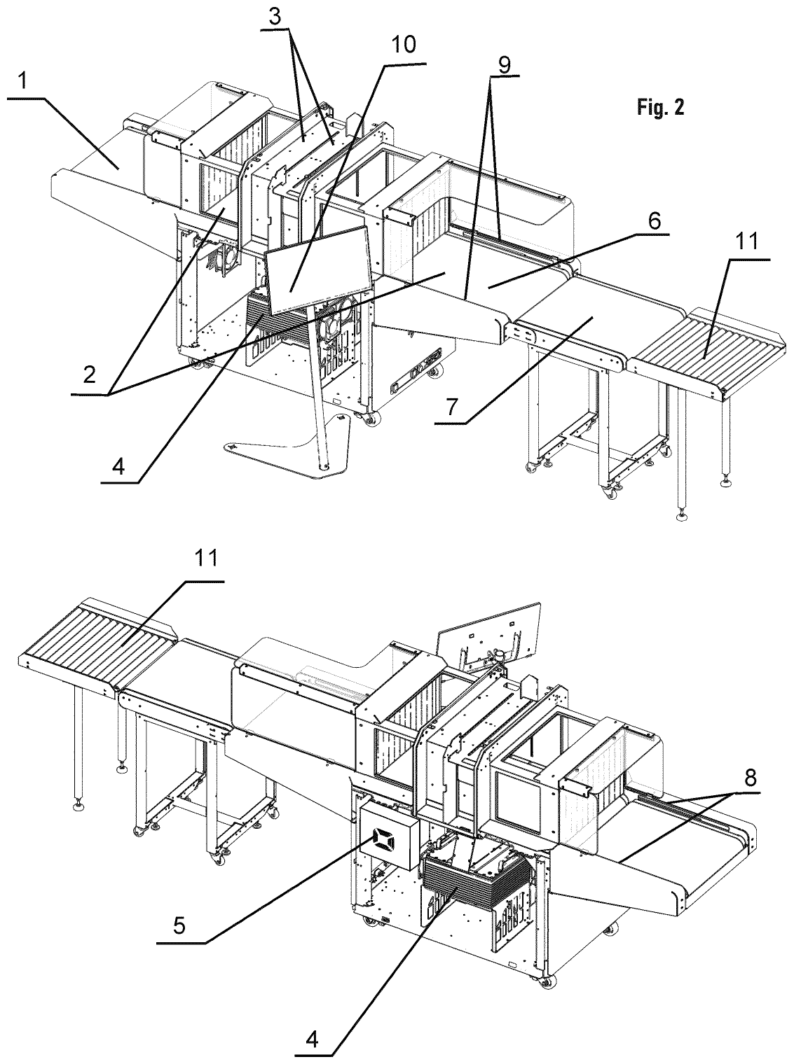

The scanner's components from FIG. 2 and operation according to one embodiment of the invention are as follows:
1—a first conveyor where hand luggage is placed before X-ray scanning; 2—the second conveyor that transports hand luggage through the X-ray beams; 3—X-ray receivers in two perspectives; 4—X-ray generators in two perspectives; 5—a computer for processing X-ray images; 6—additional inspection zone; 7—a third conveyor for transporting luggage to pick up table; 8—a first plurality of positioning sensors; 9—second plurality of positioning sensors; 10—monitor, for luggage inspection; 11—luggage pick up table.

The hand luggage screening process comprises the following steps:
1. A person places her hand luggage on the first conveyor in front of the scanner [1], which is not moving.

The first plurality of positioning sensors [8] determine whether the item is ready for inspection, and is on the first conveyor [1];

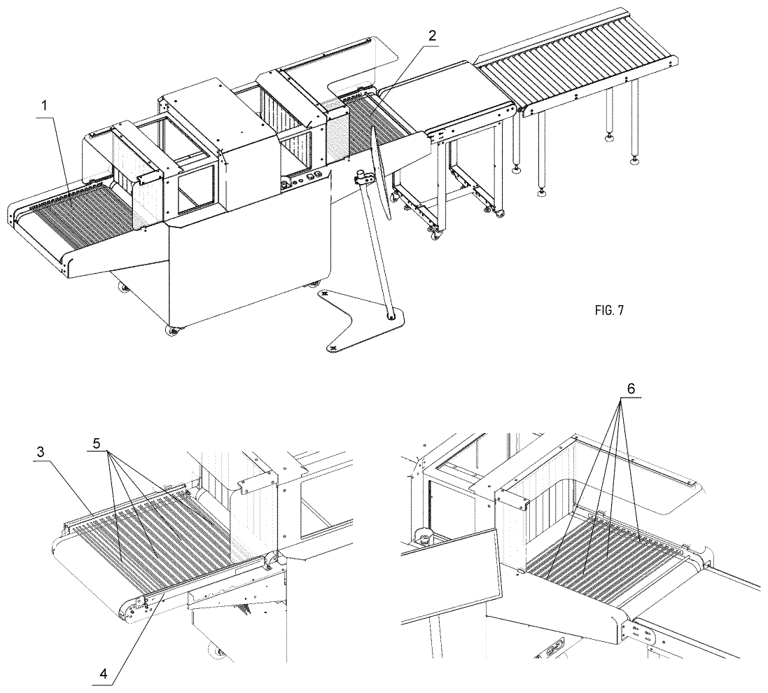

First and second pluralities of positioning sensors (See FIG. 7 position [1] and [2]) are specific sets of control optical sensors for detection of the objects between the emitter (see FIG. 7 position [3]) and receiver (see FIG. 7 position [4]) of these sensors. Emitter and receiver are positioned oppositely to each other in the same plane. The emitter and receiver consist of arrays of infrared LEDs (850 nm modulated) and photosensors respectively, housed with control electronics in aluminum housings. Any infrared ray crossing by a personal belonging is detected by infrared receiver. The area covered by the first plurality of positioning sensor infrared rays (see FIG. 7 position [5]) has the same size as a first conveyor area and the area covered by the second plurality of positioning sensor infrared rays (see FIG. 7 position [6]) has the same size as an additional inspection zone area. Such a configuration helps system to recognize with 100% certainty if personal belongings are available for inspection and if system is ready for the next inspection. It is used for automatic inspection procedure control.

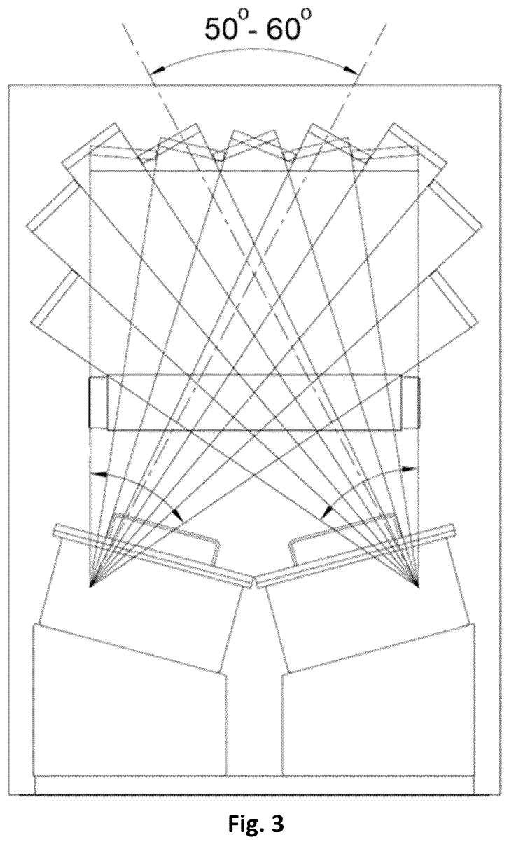

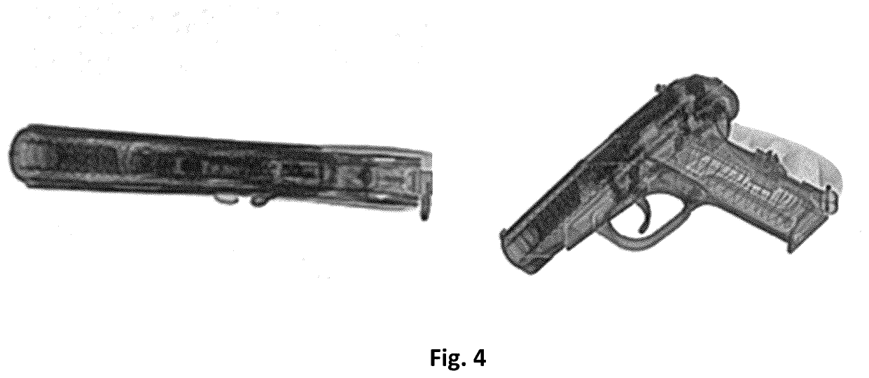

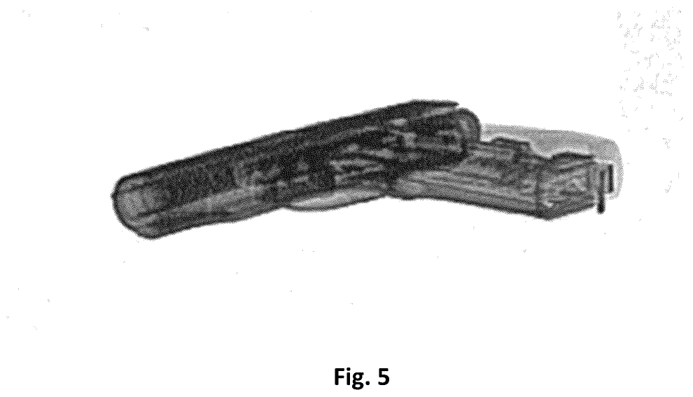

The scanner is ready for X-ray scanning of the hand luggage if the previous item's scan is completed because there are no suspicious objects or because the luggage was manually removed for manual inspection;
2. If the scanner is ready and other conditions are met, the first conveyor starts moving, feeding the hand luggage to the second conveyor [2], which moves at 0.6-0.8 mps, which is 3-5 times faster than the conveyor speed of a conventional luggage scanner.
3. The hand luggage is screened using two X-ray beams oriented at 50-60 degree angles to each other (see FIG. 3), resulting in two X-ray projections. This is an unconventional positioning of the X-ray generators.
4. X-ray generators in luggage screening systems are typically positioned at a 90-degree angle to each other. Such positioning makes it easier for the operator to inspect the bag contents on the X-ray images, as the resulting perspectives are very different (see FIG. 4). However, one aspect of the proposed invention is that the X-ray images are analyzed by machine vision algorithms rather than by a human operator. Therefore, the X-ray generators are positioned at much smaller angles (50-60 degrees) to each other. In this case, the resulting perspectives will not be very different (see FIG. 5), but it will allow to make the whole system significantly smaller without affecting the work of the machine vision algorithms. Specifically, with such a positioning of the generators, the scanner will be less than 90 cm wide and will thus fit through standard doors, making it the narrowest two-perspective system that has no counterparts on the market.

Additionally, for the machine vision algorithms to work, it is possible to reduce the power of the X-ray generator to minimally acceptable parameters, which reduces cost of the overall system and improve radiation safety. In contrast with the present system, for conventional baggage scanners, the parameters of the X-ray generator are usually chosen with some “slack” or margin, which is done to make the manual operator's job easier. In the present system, there is no need for such slack (due to the machine vision analysis), meaning the X-ray generator can have lower power.

The machine vision algorithms are capable of processing two X-ray images and detecting prohibited items in the hand luggage, based on certain characteristics. In particular, the proposed machine vision algorithms are trained to identify only the threats that are characteristic of mass events. However, the list of threats is not limited and can be expanded at any time.

An important requirement is that the threats must be detected by the algorithm with a high degree of reliability. Otherwise, if there are a large number of bags to be screened, the system may become congested and thus rendered ineffective. With higher inspection speed, the number of potential false positives can also increase, which in turn increases the work for the operator.

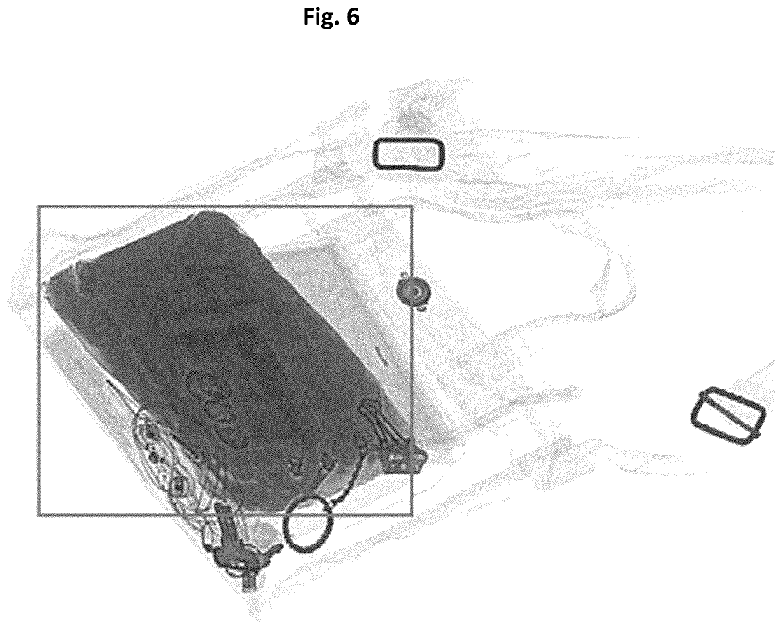

Examples of threats include firearms, knives, and pyrotechnic devices. Dense, bulky items in bags that may conceal liquid or solid explosives are another significant threat. The two-perspective geometry allows the relative volume of homogeneous items to be identified, thus helping to detect large-volume explosives that typically fill the entire bag (see FIG. 6). This function is performed by highlighting areas on the X-ray image that contain homogeneous items, calculating their areas in both perspectives and comparing them to the luggage areas in the same perspectives. The lower limit of detectable volumes is 200 cc; the minimum difference between the resulting item density and the resulting luggage material density is 30%. The homogeneity requirement means that the resulting density must be constant throughout the volume of the item. In order to highlight the areas containing homogeneous items, the Contrast Limited Adaptive Histogram Equalization (CLAHE) method is first used: The image is divided into non-intersecting parts; for each of the parts, integral pixel brightness histograms are computed; and new brightness values for each pixel of the original image are generated by bilinear interpolation of averaged area values. Otsu's thresholding method is then applied to the image, wherein pixels are divided into useful and background ones based on various intensity thresholds. Parameter changes and result averaging help to highlight areas that contain items with more accuracy. Then, for each area, border pixels are found, which are used to construct outlines of individual items; for each of the outlines, the number of pixels belonging to the item is calculated. The same algorithm is applied to the entire area of the bag, and then the area of the bag is compared to that of the items in both perspectives in order to determine the average relative volume of the items. The operator can set custom thresholds for item volumes, thus causing the algorithm to notify them about the items that fall within the specified limits and to mark their locations in both perspectives.

If no prohibited items have been detected, then the second conveyor will automatically transport the hand luggage to third conveyor and to pick up table [6] allowing the person to collect her hand luggage as soon as she approaches the zone.

If any prohibited items are detected, then main conveyor will automatically stop luggage at additional inspection zone, activate a second plurality of sensors and keep luggage stationary until security guard will not take it for manual inspection and disactivate a second plurality of sensors. Automatic inspection procedure will proceed after that;

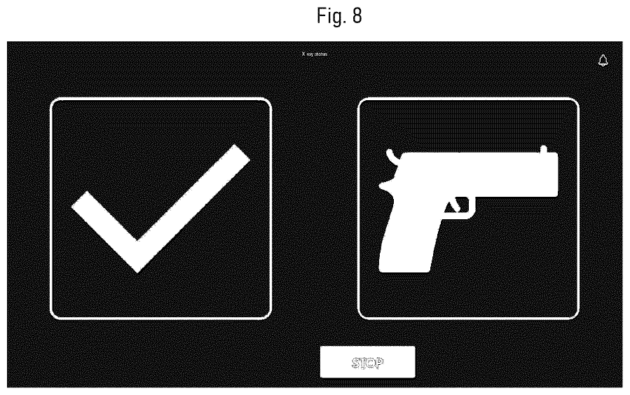

Monitor [10], displays only the type of identified threat, e.g., “firearm” in a simplified schematic format (see FIG. 8), that does not require any special knowledge from the operator about x-ray images reading. While the convenitional x-ray baggage scanners need specific operator education.

Generally, the proposed system has the following advantages over conventional systems:
1. High conveyor speed, such as up to 0.8 meters per second in this example, compared to 0.2 meters per second on conventional baggage scanners
2. Use of individualized positional sensors responsible for beginning of the scan and any scan interruptions at an optimal time, which depends on the results of the machine vision analysis. Combined with the higher conveyor speed, the system can have high throughput without suffering from congestion due to bags placed by people on the conveyor.
3. The machine vision algorithm are fast enough to analyze the luggage before it reaches the location where it is still inaccessible for luggage owner. The machine vision algorithms make the decision before the bag reaches the second plurality of sensors. Compared to conventional baggage scanners, machine vision algorithms should be several times faster, since the conveyor belt is moving 3-5 times faster. High machine vision algorithm speed makes it possible to minimize scanner size and increase overall inspection speed 3-5 times.
4. The arrangement of the three conveyors permits a maximum effective interaction between security personnel, people with luggage and the scanner itself.
5. The X-ray generator power can be lower than typically seen in such systems, e.g., by about 1.5×. It increases radiation safety and makes system more cost effective.
6. A simplified visualization of the threats permits to reduce the workload on the operator.

All of this permits relatively high throughput with relatively low requirements for security personnel, and relatively low workload for such personnel.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A scanner, comprising:
a housing;
a first conveyor that transports a luggage piece into the housing;
a first plurality of sensors that detects a presence of the luggage piece on the first conveyor;
a second conveyor that transports the luggage piece through the housing for scanning;
a second plurality of sensors that detects a presence of the luggage piece on the second conveyor;
a pick up table for luggage pieces that do not require manual inspection;
a third conveyor that transports a luggage piece to the pick up table;
wherein the first conveyor does not move the luggage piece into the housing as long as a previous luggage piece was not sent to the pick up table or until the luggage piece is taken from the second conveyor for manual inspection;
a first X-ray source with a first X-ray beam direction;
a second X-ray source with a second X-ray beam direction, wherein the first and second X-ray beam directions are 50-60 degrees apart;
wherein the first X-ray source has 100-160 KVolt on its anode;
wherein the second X-ray source has 100-160 KVolt on its anode;
a first detector that detects the first X-ray beam after the luggage piece passes through the first X-ray beam; and
a second detector that detects the second X-ray beam after the luggage piece passes through the second X-ray beam.

2. The scanner of claim 1, wherein luggage is automatically fed onto a third conveyor, based on results of luggage analysis by the machine vision algorithm in case it does not show a suspicious object in the luggage piece.

3. The scanner of claim 1, wherein the first and second X-ray sources are underneath the second conveyor.

4. The scanner of claim 1, wherein the first and second detectors are above the second conveyor.

5. The scanner of claim 1, wherein a machine vision algorithm is used to combine images from the first and second detectors, analyze images to identify threats.

6. The scanner of claim 5, further comprising a display monitor for showing machine vision image analysis results and type of threat.

7. The scanner of claim 1, further comprising a workstation with the machine vision algorithm that analyzes the X-ray images and makes a decision whether a threat is present in the luggage piece.

8. The scanner of claim 1, further comprising a display monitor where the luggage piece is further inspected if a threat is suspected.

9. A scanner, comprising:
a housing;
a first conveyor that transports a bag into the housing;
a first sensor that detects a presence of the bag on the first conveyor;
a second conveyor that transports the bag through the housing for scanning;
a second sensor that detects the bag on the second conveyor;
a pick up table for bags;
a third conveyor that transports a bag to the pick up table;
wherein the first conveyor does not transport the bag as long as a previous bag was not sent to the pick up table or until the bag is taken from the second conveyor for manual inspection;
a first X-ray source generating a first X-ray beam, wherein the first X-ray source has 100-160 KVolt on its anode;
a second X-ray source generating a second X-ray beam, wherein the second X-ray source has 100-160 KVolt on its anode,
wherein the first and second X-ray beams are 50-60 degrees apart;
a first detector that detects the first X-ray beam after the bag passes through the first X-ray beam; and
a second detector that detects the second X-ray beam after the bag passes through the second X-ray beam.
